(19) United States
(12) Patent Application Publication
(10) Pub. No.: US 2020/0092849 A1
(43) Pub. Date: Mar. 19, 2020

(54) CHANNEL STATE INFORMATION FEEDBACK METHOD, USER EQUIPMENT, AND BASE STATION

(71) Applicants: Meng ZHANG, Shanghai (CN); SHARP KABUSHIKI KAISHA, Sakai City, Osaka (JP)

(72) Inventors: MENG ZHANG, Shanghai (CN); RENMAO LIU, Shanghai (CN)

(21) Appl. No.: 16/494,674

(22) PCT Filed: Mar. 16, 2018
(86) PCT No.: PCT/CN2018/079225

§ 371 Date: Sep. 16, 2019

(30) Foreign Application Priority Data
Mar. 24, 2017 (CN) 201710186176.4

(51) Int. Cl. H04W 72/04; H04L 5/00; H04B 7/06

(52) U.S. Cl. CPC H04W 72/04; H04B 7/0626; H04L 5/0053

(57) ABSTRACT

Provided is a method executed by user equipment (UE), the method comprising: receiving, from a base station, configuration information related to channel state information (CSI) feedback of UE; and executing corresponding CSI feedback according to the configuration information. The CSI feedback comprises two or more of periodic CSI feedback, aperiodic CSI feedback, and semi-persistent scheduling CSI feedback. Also provided are a corresponding method executed by a base station, user equipment, and a base station.

### TECHNICAL FIELD

The present invention relates to the wireless communication field. More specifically, the present invention relates to a method for feeding back different types of channel state information, and corresponding user equipment and base station.

### BACKGROUND

A new research project on 5G technical standards (see non-patent literature: RP-160671: New SID Proposal: Study on New Radio Access Technology) was proposed by NTT DOCOMO at the 3rd Generation Partnership Project (3GPP) RAN #71 plenary meeting held in March 2016, and was approved. The goal of the research project is to develop a New Radio (NR) access technology to meet all of the application scenarios, requirements, and deployment environments of 5G. NR mainly has three application scenarios: Enhanced Mobile Broadband Communication (eMBB), massive Machine Type Communication (mMTC), and Ultra Reliable and Low Latency Communication (URLLC). According to the planning of the research project, the standardization of NR is conducted in two stages: the first-stage standardization will be completed by the middle of 2018; the second-stage standardization will be completed by the end of 2019. The first-stage standard specifications need to be forward-compatible with the second-stage standard specifications, while the second-stage standard specifications need to be established on the basis of the first-stage standard specifications and to meet all requirements of 5G NR technical standards.

At present, in LTE and LTE-A, feedback of UE regarding channel state information can be divided into two main types: periodic feedback and aperiodic feedback. Periodic feedback is when UE periodically feeds back channel state information according to information configured by a high layer of a base station. Aperiodic feedback is when a base station causes, by means of a specific trigger, UE to feed back channel state information irregularly.

In LTE and LTE-A, when periodic feedback and aperiodic feedback occur in the same subframe, UE transmits only the aperiodic feedback in the subframe.

### SUMMARY

In NR, in addition to periodic CSI feedback and aperiodic CSI feedback, Semi-Persistent Scheduling (SPS) CSI feedback is also supported. When any two or three of the three types of feedback occur in the same slot/subframe/time interval, how to handle a priority relationship therebetween is an inevitable problem to be solved in NR.

In addition, different types of content of CSI feedback are supported in NR. CSI Type-1 may comprise parameters such as a resource selection indication, a precoding matrix indication, and channel quality feedback. CSI Type-1 has feedback precision which may be slightly lower than that of CSI Type-2. CSI Type-2 may comprise feedback parameters of higher precision. For example, CSI Type-2 may comprise parameters such as analog channel state information feedback, a channel covariance matrix, and a channel feature vector.

When the three CSI feedback types conflict temporally, specific CSI feedback content transmitted thereby shall also be considered.

According to one aspect of the present disclosure, a method executed by user equipment (UE) is provided, comprising: receiving configuration information from a base station, the configuration information being related to channel state information (CSI) feedback of the UE, and the CSI feedback comprising two or more of periodic CSI feedback, aperiodic CSI feedback, and semi-persistent scheduling CSI feedback; and executing corresponding CSI feedback according to the configuration information.

In one embodiment, the configuration information is related to the periodic CSI feedback and the semi-persistent scheduling CSI feedback. If the periodic CSI feedback and the semi-persistent scheduling CSI feedback overlap in a specific slot in a specific time interval, then only the semi-persistent scheduling CSI feedback is executed in the entire time interval. Alternatively, if the periodic CSI feedback and the semi-persistent scheduling CSI feedback overlap in a specific slot in a specific time interval, then only the semi-persistent scheduling CSI feedback is executed in the slot. Alternatively, if the periodic CSI feedback and the semi-persistent scheduling CSI feedback overlap in a specific slot in a specific time interval, and if the feedback type of the periodic CSI feedback is different from that of the semi-persistent scheduling CSI feedback, then the periodic CSI feedback and the semi-persistent scheduling CSI feedback are executed in the slot; or, if the feedback type of the periodic CSI feedback is the same as that of the semi-persistent scheduling CSI feedback, then only the semi-persistent scheduling CSI feedback is executed in the slot.

In one embodiment, the configuration information is related to the periodic CSI feedback and the aperiodic CSI feedback. If the periodic CSI feedback and the aperiodic CSI feedback overlap in a specific slot in a specific time interval, and if the feedback type of the periodic CSI feedback is different from that of the aperiodic CSI feedback, the periodic CSI feedback and the aperiodic CSI feedback are executed in the slot; or, if the feedback type of the periodic CSI feedback is the same as that of the aperiodic CSI feedback, then only the aperiodic CSI feedback is executed in the slot.

In one embodiment, the configuration information is related to the aperiodic CSI feedback and the semi-persistent scheduling CSI feedback. If the aperiodic CSI feedback and the semi-persistent scheduling CSI feedback overlap in a specific slot in a specific time interval, and if the feedback type of the aperiodic CSI feedback is different from that of the semi-persistent scheduling CSI feedback, then the aperiodic CSI feedback and the semi-persistent scheduling CSI feedback are executed in the slot; or, if the feedback type of the aperiodic CSI feedback is the same as that of the semi-persistent scheduling CSI feedback, then only the aperiodic CSI feedback or only the semi-persistent scheduling CSI feedback is executed in the slot.

According to another aspect of the present disclosure, user equipment (UE) is provided, comprising a processor and a memory. The memory stores instructions. The instructions, when processed by the processor, execute the method described according to the present disclosure.

According to another aspect of the present disclosure, a method executed by a base station is provided, comprising: generating configuration information, the configuration information being related to channel state information (CSI) feedback of user equipment (UE), and the CSI feedback comprising two or more of periodic CSI feedback, aperiodic CSI feedback, and semi-persistent scheduling CSI feedback; and transmitting the configuration information to the UE.

According to another aspect of the present disclosure, a base station is provided, comprising a processor and a memory. The memory stores instructions. The instructions, when processed by the processor, execute the method described according to the present disclosure.

### BRIEF DESCRIPTION OF DRAWINGS

The above and other features of the present disclosure will become more apparent with the following detailed description in conjunction with the accompanying drawings.

FIG. 1 is a schematic diagram of collision between different types of channel state information feedback;

FIGS. 2(a)-2(c) are schematic diagrams of handling collision between different types of channel state information feedback according to the present disclosure;

FIG. 3 is a flowchart of a method executed by user equipment according to an embodiment of the present disclosure;

FIG. 4 is a flowchart of a method executed by a base station according to an embodiment of the present disclosure;

FIG. 5(a) is a block diagram of user equipment ding to an embodiment of the present disclosure; and

FIG. 5(b) is a block diagram of a base station according to an embodiment of the present disclosure.

### DETAILED DESCRIPTION

The following describes the present disclosure in detail with reference to the accompanying drawings and specific embodiments. It should be noted that the present disclosure should not be limited to the specific embodiments described below. In addition, for simplicity, detailed description of the known art not directly related to the present disclosure is omitted to prevent confusion in understanding the present disclosure.

Multiple implementations according to the present invention are specifically described below by using an LTE mobile communication system and its subsequent evolved version as an exemplary application environment. However, it should be noted that the present invention is not limited to the following implementations, but is applicable to other wireless communication systems, such as a future 5G or subsequent communication systems.

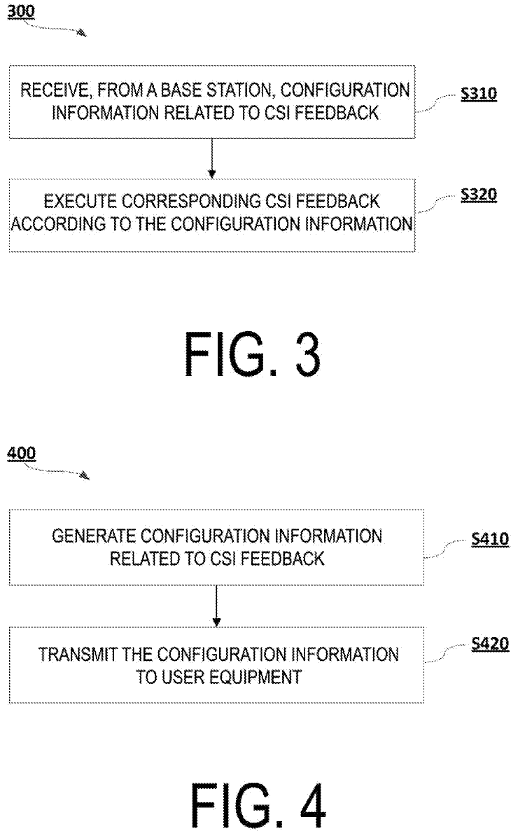

FIG. 3 is a flowchart of a method 300 executed by user equipment (UE) according to an embodiment of the present disclosure.

In step S310, user equipment receives configuration information from a base station, the configuration information being related to channel state information (CSI) feedback of the UE. For example, the CSI feedback may include two or more of periodic CSI feedback, aperiodic CSI feedback, and semi-persistent scheduling CSI feedback.

In step S320, the user equipment executes corresponding CSI feedback according to the configuration information.

In the following, execution of each step in the method 300 are described in detail using several specific examples.

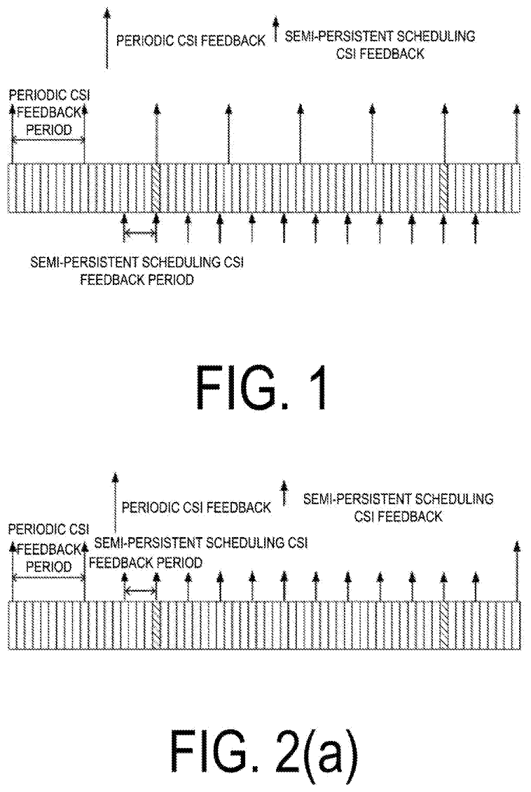

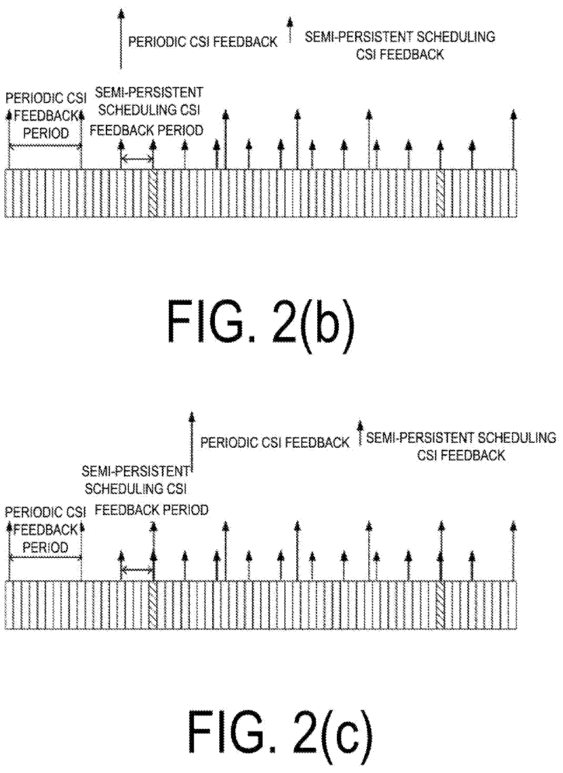

In an example, the configuration information may consist of the periodic CSI feedback and the semi-persistent scheduling CSI feedback. In this case, it is assumed that a scheduling time interval of the periodic CSI feedback overlaps with that of the semi-persistent scheduling CSI feedback, as shown in FIG. 1. Therefore, in the overlapping time interval, the UE can transmit only the semi-persistent scheduling CSI feedback, but does not transmit the periodic CSI feedback, as shown in FIG. 2(a). In other words, in the scheduling time interval of the semi-persistent scheduling CSI feedback, the periodic CSI feedback is deactivated.

In another example, the configuration information may consist of the periodic CSI feedback and the semi-persistent scheduling CSI feedback. In this case, it is still assumed that a scheduling time interval of the periodic CSI feedback overlaps with that of the semi-persistent scheduling CSI feedback, as shown in FIG. 1. Therefore, when the periodic CSI feedback and the semi-persistent scheduling CSI feedback need to be transmitted simultaneously in the same slot/subframe/time interval, the UE transmits only the semi-persistent scheduling CSI feedback in the slot/subframe/time interval, but does not transmit the periodic CSI feedback in the slot/subframe/time interval, as shown in FIG. 2(b). In other slots/subframes/time intervals, the periodic CSI feedback can be transmitted as usual.

In another example, the configuration information may consist of the periodic CSI feedback and the semi-persistent scheduling CSI feedback. In this case, it is still assumed that a scheduling time interval of the periodic CSI feedback overlaps with that of the semi-persistent scheduling CSI feedback, as shown in FIG. 1. In this case, when the periodic CSI feedback and the semi-persistent scheduling CSI feedback need to be transmitted simultaneously in the same slot/subframe/time interval, and if the feedback type of the periodic CSI feedback is different from that of the semi-persistent scheduling CSI feedback, then the UE transmits both the periodic CSI feedback and the semi-persistent scheduling CSI feedback in the slot/subframe/time interval, as shown in FIG. 2(c). On the contrary, if the feedback type of the periodic CSI feedback is the same as that of the semi-persistent scheduling CSI feedback, then the UE transmits only the semi-persistent scheduling CSI feedback in the slot/subframe/time interval.

For example, assuming that in a specific slot/subframe/time interval, the periodic CSI feedback feeds back a parameter of CSI Type I and the semi-persistent scheduling CSI feedback feeds back a parameter of CSI Type II, the UE needs to perform both the periodic CSI feedback and the semi-persistent scheduling CSI feedback in the slot/subframe/time interval. On the contrary, assuming that in a specific slot/subframe/time interval, the periodic CSI feedback feeds back a parameter of CSI Type II and the semi-persistent scheduling CSI feedback feeds back a parameter of CSI Type I, then the UE needs to perform both the periodic CSI feedback and the semi-persistent scheduling CSI feedback in the slot/subframe/time interval. Further, assuming that in a specific slot/subframe/time interval, a parameter of the periodic CSI feedback and a parameter of the semi-persistent scheduling CSI feedback are both of CSI Type I or of CSI Type II, the UE transmits only the semi-persistent scheduling CSI feedback in the slot/subframe/time interval.

In another example, the configuration information may consist of the periodic CSI feedback and the aperiodic CSI feedback. When the periodic CSI feedback and the aperiodic CSI feedback need to be transmitted simultaneously in the same slot/subframe/time interval, and if the feedback type of the periodic CSI feedback is different from that of the aperiodic CSI feedback, then the UE transmits both the periodic CSI feedback and the aperiodic CSI feedback in the slot/subframe/time interval. On the contrary, if the feedback type of the periodic CSI feedback is the same as that of the aperiodic CSI feedback, then the UE transmits only the aperiodic CSI feedback in the slot/subframe/time interval.

For example, assuming that in a specific slot/subframe/time interval, the periodic CSI feedback feeds back a parameter of CSI Type I and the aperiodic CSI feedback feeds hack a parameter of CSI Type II, then the UE needs to perform both the periodic CSI feedback and the aperiodic CSI feedback in the slot/subframe/time interval. Further, assuming that in a specific slot/subframe/time interval, the periodic CSI feedback feeds back a parameter of CSI Type II and the aperiodic CSI feedback feeds back a parameter of CSI Type I, then the UE needs to perform both the periodic CSI feedback and the aperiodic CSI feedback in the slot/subframe/time interval. On the contrary, assuming that in a specific slot/subframe/time interval, a parameter of the periodic CSI feedback and a parameter of the aperiodic CSI feedback are both of CSI Type I or of CSI Type II, the UE transmits only the aperiodic CSI feedback in the slot/subframe/time interval.

In another example, the configuration information may consist of the semi-persistent scheduling CSI feedback and the aperiodic CSI feedback. When the semi-persistent scheduling CSI feedback and the aperiodic CSI feedback need to be transmitted simultaneously in the same slot/subframe/time interval, and if the feedback type of the semi-persistent scheduling CSI feedback is different from that of the aperiodic CSI feedback, then the UE needs to transmit both the semi-persistent scheduling CSI feedback and the aperiodic CSI feedback in the slot/subframe/time interval. On the contrary, if the feedback type of the semi-persistent scheduling CSI feedback is the same as that of the aperiodic CSI feedback, then the UE transmits only the semi-persistent scheduling CSI feedback or only the aperiodic CSI feedback in the slot/subframe/time interval.

For example, assuming that in a specific slot/subframe/time interval, the semi-persistent scheduling CSI feedback feeds back a parameter of CSI Type I and the aperiodic CSI feedback feeds back a parameter of CSI Type II, then the UE performs both the semi-persistent scheduling CSI feedback and the aperiodic CSI feedback in the slot/subframe/time interval. Further, assuming that in a specific slot/subframe/time interval, the semi-persistent scheduling CSI feedback feeds back a parameter of CSI Type II and the aperiodic CSI feedback feeds back a parameter of CSI Type I, then the UE performs both the semi-persistent scheduling CSI feedback and the aperiodic CSI feedback in the slot/subframe/time interval. On the contrary, assuming that in a specific slot/subframe/time interval, a parameter of the semi-persistent scheduling CSI feedback and a parameter of the aperiodic CSI feedback are both of CSI Type I or of CSI Type II, then the UE transmits only the semi-persistent scheduling CSI feedback or only the aperiodic CSI feedback in the slot/subframe/time interval.

FIG. 4 is a flowchart of a method 400 executed by a base station (BS) according to an embodiment of the present disclosure.

In step S410, a base station generates configuration information, the configuration information being related to channel state information (CSI) feedback of user equipment (UE). For example, the CSI feedback may include two or more of periodic CSI feedback, aperiodic CSI feedback, and semi-persistent scheduling CSI feedback.

In step S420, the base station transmits the configuration information to the UE.

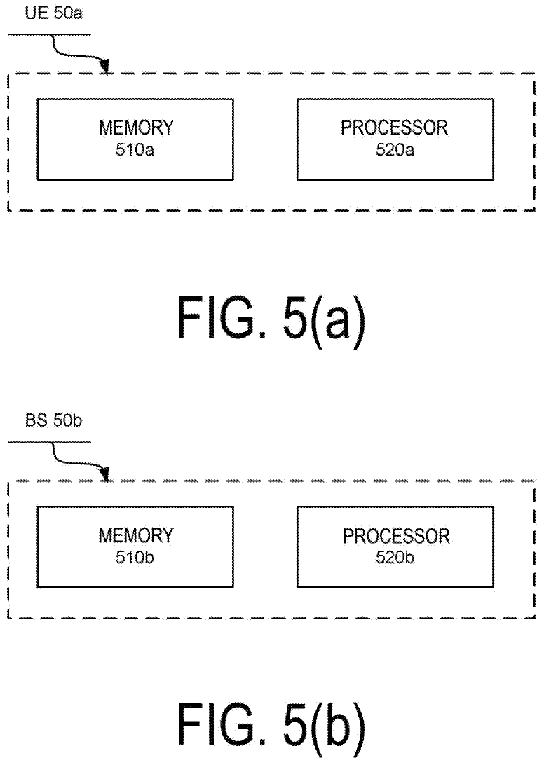

FIG. 5(a) is a block diagram of user equipment 50a according to an embodiment of the present disclosure. As shown in FIG. 5(a), the user equipment 50a includes a processor 510a and a memory 520a. The processor 510a may include, for example, a microprocessor, a microcontroller, an embedded processor, or the like. The memory 520a may include, for example, a volatile memory (for example, a random access memory (RAM)), a hard disk drive (HDD), a non-volatile memory (for example, a flash memory), or other memories. Program instructions are stored on the memory 520a. The instructions, when processed by the processor 510a, can perform the above method executed by user equipment described in detail in the present disclosure.

FIG. 5(b) is a block diagram of a base station (BS) 50b according to an embodiment of the present disclosure. As shown in FIG. 5(b), the BS 50b includes a processor 510b and a memory 520b. The processor 510b may include, for example, a microprocessor, a microcontroller, an embedded processor, or the like. The memory 520b may include, for example, a volatile memory (for example, a random access memory (RAM)), a hard disk drive (HDD), a non-volatile memory (for example, a flash memory), or other memories. Program instructions are stored on the memory 520b. The instructions, when processed by the processor 510b, can perform the above method executed by a base station described in detail in the present disclosure.

The program running on the device according to the present invention may be a program that enables the computer to implement the functions of the embodiments of the present invention by controlling a central processing unit (CPU). The program or information processed by the program can be stored temporarily in a volatile memory (for example, a random access memory (RAM)), a hard disk drive (HDD), a non-volatile memory (for example, a flash memory), or other memory systems.

The program for implementing the functions of the embodiments of the present invention may be recorded on a computer-readable recording medium. The corresponding functions can be achieved by reading programs recorded on the recording medium and executing them by the computer system. The so-called “computer system” herein may be a computer system embedded in the device, which may include operating systems or hardware (for example, peripherals). The “computer-readable recording medium” may be a semiconductor recording medium, an optical recording medium, a magnetic recording medium, a recording medium for programs that are dynamically stored for a short time, or any other recording medium readable by a computer.

Various features or functional modules of the device used in the above embodiments may be implemented or executed through circuits (for example, monolithic or multi-chip integrated circuits). Circuits designed to execute the functions described in this description may include general-purpose processors, digital signal processors (DSPs), application specific integrated circuits (ASICs), field programmable gate arrays (FPGAs) or other programmable logic devices, discrete gates or transistor logic, or discrete hardware components, or any combination of the above. The general-purpose processor may be a microprocessor, or may be any existing processor, a controller, a microcontroller, or a state machine. The circuit may be a digital circuit or an analog circuit. When new integrated circuit technologies that replace existing integrated circuits emerge because of the advances in semiconductor technology, one or a plurality of embodiments of the present invention may also be implemented using these new integrated circuit technologies.

Furthermore, the present invention is not limited to the embodiments described above. Although various examples of the embodiments have been described, the present invention is not limited thereto. Fixed or non-mobile electronic devices installed indoors or outdoors, such as AV equipment, kitchen equipment, cleaning equipment, air conditioner, office equipment, vending machines, and other household appliances, may be used as terminal devices or communications devices.

The embodiments of the present invention have been described in detail above with reference to the accompanying drawings. However, the specific structures are not limited to the above embodiments. The present invention also includes any design modifications that do not depart from the main idea of the present invention. In addition, various modifications can be made to the present invention within the scope of the claims. Embodiments resulted from the appropriate combinations of the technical means disclosed in different embodiments are also included within the technical scope of the present invention. In addition, components with the same effect described in the above embodiments may be replaced with one another.

1. A method executed by user equipment (UE), comprising:
receiving configuration information from a base station, the configuration information being related to channel state information (CSI) feedback of the UE, the CSI feedback comprising two or more of periodic CSI feedback, aperiodic CSI feedback, and semi-persistent scheduling CSI feedback; and
executing corresponding CSI feedback according to the configuration information.

2. The method according to claim 1, wherein the configuration information is related to the periodic CSI feedback and the semi-persistent scheduling CSI feedback, and the executing corresponding CSI feedback according to the configuration information comprises the following:
if the periodic CSI feedback and the semi-persistent scheduling CSI feedback overlap in a specific slot in a specific time interval, then only the semi-persistent scheduling CSI feedback is executed in the entire time interval; or
if the periodic CSI feedback and the semi-persistent scheduling CSI feedback overlap in a specific slot in a specific time interval, then only the semi-persistent scheduling CSI feedback is executed in the slot; or
if the periodic CSI feedback and the semi-persistent scheduling CSI feedback overlap in a specific slot in a specific time interval, and if the feedback type of the periodic CSI feedback is different from that of the semi-persistent scheduling CSI feedback, then the periodic CSI feedback and the semi-persistent scheduling CSI feedback are executed in the slot; or, if the feedback type of the periodic CSI feedback is the same as that of the semi-persistent scheduling CSI feedback, then only the semi-persistent scheduling CSI feedback is executed in the slot.

3. The method according to claim 1, wherein the configuration information is related to the periodic CSI feedback and the aperiodic CSI feedback, and the executing corresponding CSI feedback according to the configuration information comprises the following:
if the periodic CSI feedback and the aperiodic CSI feedback overlap in a specific slot in a specific time interval, and if the feedback type of the periodic CSI feedback is different from that of the aperiodic CSI feedback, then the periodic CSI feedback and the aperiodic CSI feedback are executed in the slot; or, if the feedback type of the periodic CSI feedback is the same as that of the aperiodic CSI feedback, then only the aperiodic CSI feedback is executed in the slot.

4. The method according to claim 1, wherein the configuration information is related to the aperiodic CSI feedback and the semi-persistent scheduling CSI feedback, and the executing corresponding CSI feedback according to the configuration information comprises the following:
if the aperiodic CSI feedback and the semi-persistent scheduling CSI feedback overlap in a specific slot in a specific time interval, and if the feedback type of the aperiodic CSI feedback is different from that of the semi-persistent scheduling CSI feedback, then the aperiodic CSI feedback and the semi-persistent scheduling CSI feedback are executed in the slot; or, if the feedback type of the aperiodic CSI feedback is the same as that of the semi-persistent scheduling CSI feedback, then only the aperiodic CSI feedback or only the semi-persistent scheduling CSI feedback is executed in the slot.

5. User equipment (UE), comprising:
a processor; and
a memory, the memory having instructions stored thereon, wherein
the instructions, when processed by the processor, execute the method according to claim 1.

6. A method executed by a base station, comprising:
generating configuration information, the configuration information being related to channel state information (CSI) feedback of user equipment (UE), and the CSI feedback comprising two or more of periodic CSI feedback, aperiodic CSI feedback, and semi-persistent scheduling CSI feedback; and
transmitting the configuration information to the UE.

7. The method according to claim 6, wherein the configuration information is related to the periodic CSI feedback and the semi-persistent scheduling CSI feedback, and the configuration information instructs the UE to execute the following operation:
if the periodic CSI feedback and the semi-persistent scheduling CSI feedback overlap in a specific slot in a specific time interval, then only the semi-persistent scheduling CSI feedback is executed in the entire time interval; or
if the periodic CSI feedback and the semi-persistent scheduling CSI feedback overlap in a specific slot in a specific time interval, then only the semi-persistent scheduling CSI feedback is executed in the slot; or
if the periodic CSI feedback and the semi-persistent scheduling CSI feedback overlap in a specific slot in a specific time interval, and if the feedback type of the periodic CSI feedback is different from that of the semi-persistent scheduling CSI feedback, then the periodic CSI feedback and the semi-persistent scheduling CSI feedback are executed in the slot; or, if the feedback type of the periodic CSI feedback is the same as that of the semi-persistent scheduling CSI feedback, then only the semi-persistent scheduling CSI feedback is executed in the slot.

8. The method according to claim 6, wherein the configuration information is related to the periodic CSI feedback and the aperiodic CSI feedback, and the configuration information instructs the UE to execute the following operation:
if the periodic CSI feedback and the aperiodic CSI feedback overlap in a specific slot in a specific time interval, and if the feedback type of the periodic CSI feedback is different from that of the aperiodic CSI feedback, then the periodic CSI feedback and the aperiodic CSI feedback are executed in the slot; or, if the feedback type of the periodic CSI feedback is the same as that of the aperiodic CSI feedback, then only the aperiodic CSI feedback is executed in the slot.

9. The method according to claim 6, wherein the configuration information is related to the aperiodic CSI feedback and the semi-persistent scheduling CSI feedback, and the configuration information instructs the UE to execute the following operation:
if the aperiodic CSI feedback and the semi-persistent scheduling CSI feedback overlap in a specific slot in a specific time interval, and if the feedback type of the aperiodic CSI feedback is different from that of the semi-persistent scheduling CSI feedback, then the aperiodic CSI feedback and the semi-persistent scheduling CSI feedback are executed in the slot; or, if the feedback type of the aperiodic CSI feedback is the same as that of the semi-persistent scheduling CSI feedback, then only the aperiodic CSI feedback or only the semi-persistent scheduling CSI feedback are executed in the slot.

10. A base station, comprising:
a processor; and
a memory, the memory having instructions stored thereon, wherein
the instructions, when processed by the processor, execute the method according to claim 6.
